(19) United States
(12) Patent Application Publication
(10) Pub. No.: US 2026/0261753 A1
(43) Pub. Date: Sep. 3, 2026

(54) IMAGE PICKUP APPARATUS, ITS CONTROL METHOD, AND STORAGE MEDIUM

(71) Applicant: CANON KABUSHIKI KAISHA, Tokyo (JP)

(72) Inventor: NOBUTAKA MIZUNO, Tokyo (JP)

(21) Appl. No.: 19/544,586

(22) Filed: Feb. 19, 2026

(30) Foreign Application Priority Data
Mar. 3, 2025 (JP) 2025-032755

(51) Int. Cl. H04N 23/61; H04N 23/62; H04N 23/63; H04N 23/67

(52) U.S. Cl. CPC H04N 23/61; H04N 23/62; H04N 23/632; H04N 23/67

(57) ABSTRACT

An image pickup apparatus detects an object of a type as a detection target selected according to a user operation from image data obtained by imaging through an optical system, controls the optical system so as to include a plurality of objects at different distances within a depth of field of the optical system, and changes the plurality of objects according to the user operation to include an object not detected by detecting the object.

### BACKGROUND

### Field of the Technology

The aspect of the disclosure relates to one or more embodiments of an image pickup apparatus, its control method, and a storage medium.

### Description of the Related Art

Image pickup apparatuses are demanded to have the ability to simultaneously focus on a plurality of objects that are located at different distances from one another.

Japanese Patent Application Laid-Open No. 2018-064285 discloses an image pickup apparatus that includes a plurality of moving objects within the depth of field by controlling the aperture stop of the optical system based on information about their distances (positions in the depth direction). Japanese Patent Application Laid-Open No. 2010-127995 discloses an image pickup apparatus that allows the user to select a face to be included within a predetermined depth of field from among a plurality of detected faces.

The image pickup apparatuses disclosed in Japanese Patent Applications Laid-Open Nos. 2018-064285 and 2010-127995 first detect an object that can be included within the depth of field. In this case, in a case where the object to be focused on is not included among the objects detected by the image pickup apparatus, that object cannot be included within the depth of field.

### SUMMARY

One or more embodiments of an image pickup apparatus according to one or more aspects of the disclosure may include one or more memories storing instructions, and one or more processors that, upon execution of the instructions, operate to detect an object of a type as a detection target selected according to a user operation from image data obtained by imaging through an optical system, control the optical system so as to include a plurality of objects at different distances within a depth of field of the optical system, and change the plurality of objects according to the user operation to include an object not detected by detecting the object. A control method corresponding to the above image pickup apparatus also constitutes another aspect of the disclosure. A storage medium storing a program that causes a computer to execute the above control method also constitutes another aspect of the disclosure.

Features of the present disclosure will become apparent from the following description of embodiments with reference to the attached drawings. The following description of embodiments is described by way of example.

### BRIEF DESCRIPTION OF THE DRAWINGS

FIG. 1 is a block diagram illustrating the configuration of an image pickup apparatus according to this embodiment.

FIG. 2 illustrates the pixel arrangement on an image sensor in this embodiment.

FIG. 3 illustrates a display example of a display device in this embodiment.

FIGS. 4A and 4B illustrate another display example of a display device in this embodiment.

FIG. 5 illustrates yet another display example of a display device in this embodiment.

FIG. 6 illustrates another display example of a display device in this embodiment.

FIG. 7 is a flowchart illustrating processing executed in this embodiment.

FIGS. 8A, 8B, 8C, and 8D illustrate examples of defocus maps in this embodiment.

FIG. 9 illustrates a defocus histogram example in this embodiment.

### DESCRIPTION OF THE EMBODIMENTS

In the following, the term “unit” may refer to a software context, a hardware context, or a combination of software and hardware contexts. In the software context, the term “unit” refers to a functionality, an application, a software module, a function, a routine, a set of instructions, or a program that can be executed by a programmable processor such as a microprocessor, a central processing unit (CPU), or a specially designed programmable device or controller. A memory contains instructions or programs that, when executed by the CPU, cause the CPU to perform operations corresponding to units or functions. In the hardware context, the term “unit” refers to a hardware element, a circuit, an assembly, a physical structure, a system, a module, or a subsystem. Depending on the specific embodiment, the term “unit” may include mechanical, optical, or electrical components, or any combination of them. The term “unit” may include active (e.g., transistors) or passive (e.g., capacitor) components. The term “unit” may include semiconductor devices having a substrate and other layers of materials having various concentrations of conductivity. It may include a CPU or a programmable processor that can execute a program stored in a memory to perform specified functions. The term “unit” may include logic elements (e.g., AND, OR) implemented by transistor circuits or any other switching circuits. In the combination of software and hardware contexts, the term “unit” or “circuit” refers to any combination of the software and hardware contexts as described above. In addition, the term “element,” “assembly,” “component,” or “device” may also refer to “circuit” with or without integration with packaging materials.

Referring now to the accompanying drawings, a detailed description will be given of embodiments according to the disclosure.

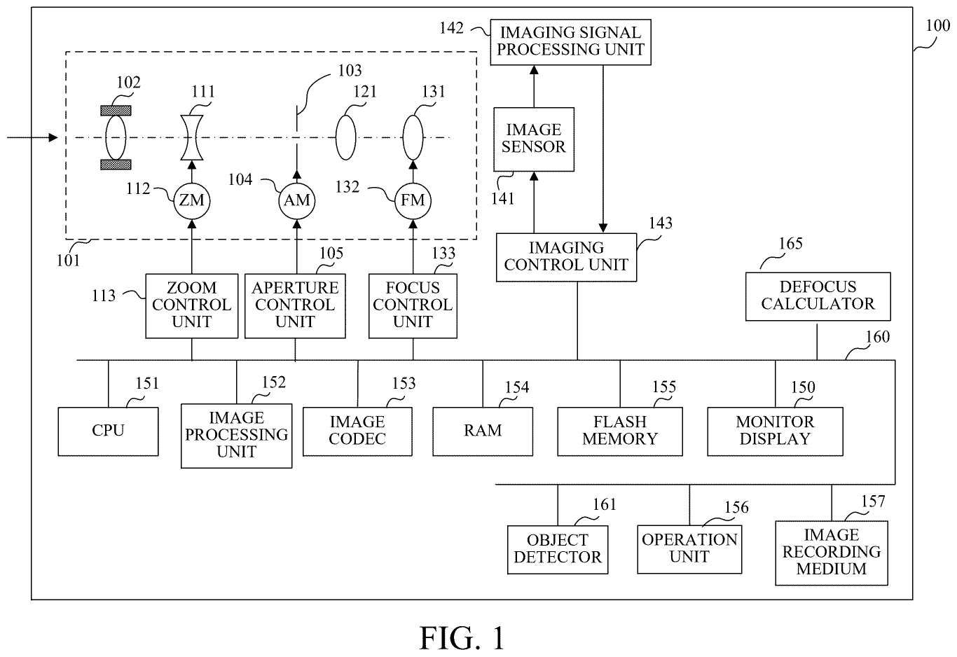

FIG. 1 illustrates the configuration of an image pickup apparatus 100 according to this embodiment. The image pickup apparatus 100 is a digital still camera, video camera, or the like that can record moving and still image data generated by capturing an object image onto a variety of media such as semiconductor memory or optical discs.

The image pickup apparatus 100 includes a lens unit 101, a zoom control unit 113, an aperture control unit 105, a focus control unit 133, an image sensor 141, an imaging signal processing unit 142, an imaging control unit 143, a CPU 151, an image processing unit 152, and an image compression/decompression unit (CODEC) 153. The image pickup apparatus 100 further includes an object detector 161, an operation unit 156, and a defocus calculator 165. The above units are connected to each other via a bus 160.

The lens unit 101 includes an imaging optical system. The imaging optical system includes, in order from the object side, a first lens unit 102, a zoom lens 111, an aperture stop 103, a third lens unit 121, and a focus lens 131. Each lens includes one or more lenses. The lens unit 101 may be attachable to and detachable from a body including an image sensor 141 in the image pickup apparatus 100, or may be integrated into the body.

The aperture control unit 105 drives the aperture stop 103 by controlling the aperture motor (AM) 104 in accordance with instructions from the CPU 151. The aperture stop 103 adjusts a light amount by changing the aperture diameter. The zoom control unit 113 drives the zoom lens 111 in the optical axis direction by controlling the zoom motor (ZM) 112, thereby changing the focal length of the imaging optical system.

The focus control unit 133 calculates a drive amount of the focus lens 131 to achieve focus, based on a focus shift amount (defocus amount) of the imaging optical system calculated by the defocus calculator 165. The focus control unit 133 drives the focus lens 131 by controlling a focus motor (FM) 132 according to the calculated drive amount. Thus, the focus control unit 133 performs AF control.

The imaging optical system forms an optical image of the object by condensing light from the object on the image sensor 141. The image sensor 141 converts the object image into an electrical imaging signal. The image sensor 141 is a photoelectric conversion element such as a CCD sensor or CMOS sensor.

The imaging signal processing unit 142 performs signal processing on an imaging signal from the image sensor 141 to generate image data. The image data is sent to the imaging control unit 143 and is temporarily stored in a RAM 154.

The image CODEC 153 compresses the image data stored in the RAM 154. This compressed image data is recorded on an image recording medium 157. In parallel with this, the image data stored in the RAM 154 is sent to the image processing unit 152.

The image processing unit 152 performs processing such as resizing to reduce or enlarge the image data to an optimal size. The image data sequentially generated by the imaging signal processing unit 142 and processed to the optimal size by the image processing unit 152 is displayed on a monitor display (display unit: simply referred to as a monitor hereinafter) 150, which is a display device such as an LCD. This displays a preview (live-view) image. The monitor 150 can also superimpose a rectangular detection frame surrounding a specific object detected by the object detector 161, described below, on the preview image.

The RAM 154 can buffer multiple image data (frame images) obtained by imaging (shooting) within a predetermined period and the object detection result for each frame image.

The operation unit 156 is an input interface including buttons, dials, and a touch panel on the monitor 150, and is operable by the user to select a variety of functions included in the menu displayed on the monitor 150 and to instruct a variety of operations.

The CPU 151, which serves as a control unit, is a computer in the image pickup apparatus 100. The CPU 151 determines the accumulation time of the image sensor 141 and the gain setting value when outputting from the image sensor 141 to the imaging signal processing unit 142 based on user instructions input from the operation unit 156 and pixel signal values of image data temporarily stored in the RAM 154. The imaging control unit 143 controls the image sensor 141 based on instructions for the accumulation time and gain setting values received from the CPU 151.

The object detector 161 performs detection processing to detect a specific object (referred to as a specific object hereinafter) within the image data. In this embodiment, the object includes not only the entire individual body, such as a person or animal, but also parts of the individual body, such as a face, torso, or legs of a person or animal. The specific object is a person's face, an animal's face, or the like, and is set in advance by the user. The specific object is detected based on dictionary data created in advance through machine learning using images of the specific object as training data. A method called a convolutional neural network (CNN) can be used as an object detecting method using machine learning. The CNN performs inference processing based on image data and dictionary data, which are processing parameters. The dictionary data is generated in advance through training processing based on training data.

The focus control unit 133 performs AF control for a detected specific object. The aperture control unit 105 performs exposure control using a luminance value of the area of the image data that contains the specific object. The image processing unit 152 performs the resizing processing described above, as well as gamma correction and white balance processing for the area of the image data that contains the specific object.

A flash memory 155 stores programs and parameters necessary for the operation of the CPU 151, etc. When the image pickup apparatus 100 is turned on by a user operation, the programs and parameters stored in the flash memory 155 are loaded into part of the RAM 154. The CPU 151, etc. operates according to the programs and parameters loaded into the RAM 154. The user can set AF settings such as AF speed and tracking characteristics by performing AF operations while viewing the menu displayed on the monitor 150. The AF settings at this time are also recorded in the flash memory 155.

The defocus calculator 165, which serves as a defocus acquiring unit, calculates a defocus amount as defocus information in a focus detecting area in the image data that can be a target area for focusing by AF. The defocus amount may be calculated for one focus detecting area or for a plurality of focus detecting areas. The defocus calculator 165 in this embodiment generates map information (referred to as a defocus map hereinafter) that indicates the defocus amount calculated for each of the plurality of focus detections arranged in all or part of the image data. The generated defocus map is stored in the RAM 154 and referenced by the image processing unit 152. The focus control unit 133 calculates a drive amount of the focus lens 131 for focusing based on this defocus map.

The CPU 151 also controls the imaging optical system (controls the aperture value, which will be described later) based on the defocus map so that a plurality of objects detected by the object detector 161 and located at different distances from each other (depth-priority objects, which will be described later) are included within the depth of field of the imaging optical system. At this time, the CPU 151 can change the plurality of depth-priority objects so that objects that have not been detected by the object detector 161 are included, in accordance with the user operation on the operation unit 156. The operation unit 156 and the CPU 151 constitute a changing unit.

The flash memory 155 (and unillustrated ROM and memory) serve as one or more memories storing instructions. The CPU 151 and the object detector 161 serves as one or more processors that, upon execution of the instructions, operate to detect objects of a type as a detection target selected according to a user operation from image data obtained by imaging through an optical system, control the optical system so as to include a plurality of objects at different distances within a depth of field of the optical system, and change the plurality of objects according to the user operation to include an object not detected by detecting the objects.

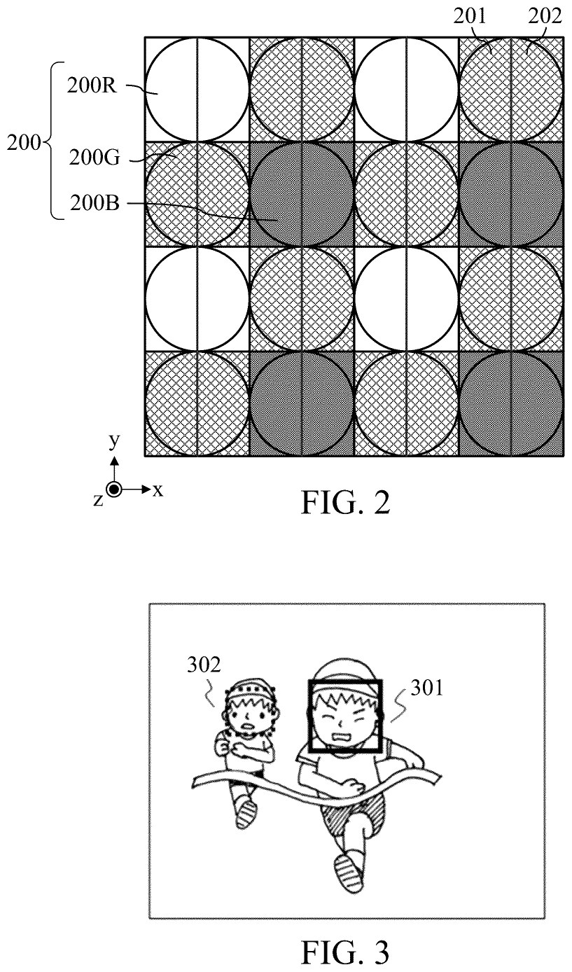

FIG. 2 illustrates the pixel array on the image sensor 141. Here, the image sensor 141 illustrates a range of 4 columns×4 rows of imaging pixels when it is a two-dimensional CMOS sensor. Within this imaging pixel range, 8 columns×4 rows of focus detecting pixels are arranged.

An imaging pixel group 200 having 2 columns×2 rows in FIG. 2 includes one imaging pixel 200R with R (red) spectral sensitivity, two imaging pixels 200G with G (green) spectral sensitivity, and one imaging pixel 200B with B (blue) spectral sensitivity. Each imaging pixel includes focus detecting pixels (a first focus detecting pixel 201 and a second focus detecting pixel 202) arranged in a 2-column×1-row configuration. The defocus calculator 165 can calculate the defocus amount in imaging pixel units using signals output from the first focus detecting pixel 201 and the second focus detecting pixel 202.

This embodiment illustrates an example in which each imaging pixel includes focus detecting pixels divided into two horizontally. However, the number of divisions in the horizontal direction may be greater than two, or the imaging pixel may be divided into two or more in the vertical direction only, or into two or more in the horizontal and vertical directions.

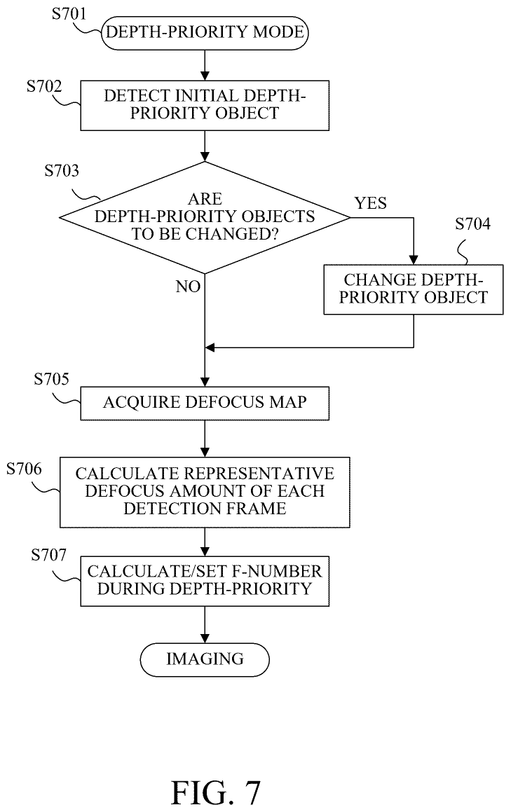

The flowchart in FIG. 7 illustrates the processing executed by the CPU 151 in accordance with a computer program. Here, the processing executed by the CPU 151 when the depth-priority mode is selected by the user will be described. The depth-priority mode is an imaging mode that simultaneously focuses on a plurality of depth-priority objects, that is, prioritizes inclusion of these depth-priority objects within the depth of field of the imaging optical system. The depth-priority objects include not only specific objects but also objects designated by the user, as described below.

When the user selects depth-priority mode as the imaging mode in step S701, the CPU 151 performs processing in step S702.

In step S702, the CPU 151 causes the object detector 161 to detect specific objects within the image data, and then causes the defocus calculator 165 to calculate a defocus amount for the detected specific objects, and performs AF control using that defocus amount. The CPU 151 then sets the specific objects included within the depth of field corresponding to the F-number initially set by the user as initial depth-priority objects, and displays a detection frame surrounding the initial depth-priority objects superimposed on the image data displayed on the monitor 150.

Next, in step S703, the CPU 151 prompts the user to select whether or not to change the plurality of depth-priority objects from the initial depth-priority objects to a plurality of objects intended by the user (which may or may not include the initial depth-priority objects). The selection of whether or not to change the depth-priority objects is performed by the user operation adding or changing a specific object, adding or deleting a depth-priority object, or changing the depth-priority object detecting area, as described below. Details will be described later.

In a case where the depth-priority objects are to be changed, the CPU 151 performs the processing of step S704; otherwise, the CPU 151 performs the processing of step S705.

In step S704, the CPU 151 causes the object detector 161 to detect a plurality of objects intended by the user as depth-priority objects. Then, the CPU 151 performs the processing of step S705.

In step S705, the CPU 151 causes the defocus calculator 165 to generate a defocus map of the entire image data or of an area including the plurality of depth-priority objects. At this time, defocus amounts may be obtained in a plurality of focus detecting areas for a single depth-priority object.

Next, in step S706, the CPU 151 calculates a representative defocus amount for each of the plurality of depth-priority objects from the defocus map. The calculation of the representative defocus amount will be described later.

Next, in step S707, the CPU 151 calculates and sets an aperture value (F-number) for including all of the plurality of depth-priority objects within the depth of field, based on the representative defocus amounts for the plurality of depth-priority objects. The calculation of the F-number at this time will be described later.

The CPU 151 drives the aperture stop 103 via the aperture control unit 105 so as to achieve the calculated F-number. Then, this flow ends.

The above processing can capture an image in which all depth-priority objects intended by the user are in focus.

The depth-priority mode will be described in detail with reference to FIG. 3. FIG. 3 illustrates a state in which a main object (the face of the leading runner) 301, which is the object to be most preferentially focused on in image data, and a secondary object (the face of the second leading runner) 302, which is also the object to be focused on with the main object 301, have been detected. In this state, a defocus amount Def1[mm] of the main object 301, with a primary frame (solid line) superimposed as a detection frame, and a defocus amount Def2[mm] of the secondary object 302, with a secondary frame (broken line) superimposed as a detection frame, are acquired.

The depth of field is expressed as 1Fδ [mm], the product of the F-number F and the permissible circle of confusion diameter δ. The permissible circle of confusion diameter δ varies according to the pixel size of image sensor 141, and therefore the depth of field also varies. However, this embodiment controls the depth of field of the imaging optical system by changing the F-number.

As illustrated in equation (1) below, when an F-number is set such that the absolute value of Def1 is 1Fδ or less, the main object 301 is included within the depth of field. Similarly, as illustrated in equation (2), when an F-number is set such that the absolute value of Def2 is 1Fδ or less, the secondary object 302 is included within the depth of field.

$$\vert Def 1 \vert \leq 1 F δ \qquad ( 1 )$$

$$\vert Def 2 \vert \leq 1 F δ \qquad ( 2 )$$

Therefore, by setting an F-number that satisfies both equations (1) and (2), both the main object 301 and the secondary object 302 can be contained within the depth of field. In this case, while the focus position can be set at an intermediate position between the main object 301 and the secondary object 302, from the perspective of achieving more accurate focus on the main object, a focus position that satisfies equations (1) and (2) may be set and |Def1|<|Def2|may be satisfied.

The following provides a detailed description of the “depth-priority object,” “adding or changing a specific object,” “adding or deleting a depth-priority object,” “changing the depth-priority object detecting area,” “defocus map,” and “representative defocus amount” used in the above processing.

### Depth-Priority Object

A depth-priority object is an object that is included within the depth of field in the depth-priority mode. Technologies have conventionally been proposed for automatically detecting depth-priority objects and including the detected depth-priority objects within the depth of field, but these conventional techniques sometimes detect only an object different from the one intended by the user.

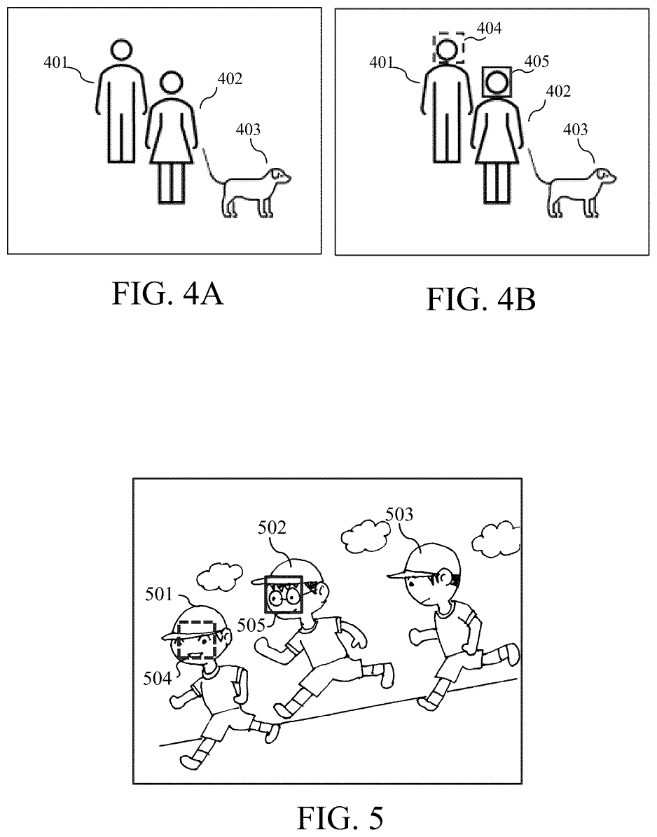

For example, FIG. 4A illustrates image data of a scene in which persons 401, 402, and a dog 403 appear, in that order from a far side to a close side of the image pickup apparatus 100. As illustrated in FIG. 4B, in a case where the faces of the persons 401 and 402 (initial depth-priority objects) are automatically detected, a primary frame 405 is displayed superimposed on the face of the person 402, and a secondary frame 404 is displayed superimposed on the face of person 402. In this state, in a case where the F-number is set so that only the faces of the persons 401 and 402 are included within the depth of field, the dog 403 will be blurred in the image. In other words, a user who wishes to capture an image by focusing not only on the faces of the persons 401 and 402 but also on the dog 403 will not be able to properly capture an image.

In contrast, this embodiment enables the user to capture an image in the depth-priority mode with all intended objects in focus. Thus, the image pickup apparatus 100 has the functions of “adding or changing a specific object,” “adding or deleting a depth-priority object,” and “changing a depth-priority object detecting area.”

### Adding or Changing Specific Object

In the depth-priority mode, as illustrated in FIG. 4B, in a case where only the faces of the persons 401 and 402 are detected as specific objects and initially detected as depth-priority objects, a user operation to add an animal (or its face) to the specific object will cause the dog 403 to be detected as a depth-priority object. This sets the F-number so that the faces of the persons 401 and 402 and the dog 403 are all included within the depth of field.

In order to include only the animals within the depth of field in a scene where the faces of the persons and a plurality of animals are mixed, the faces of the persons as specific objects may be deleted and a change is made to include only the animal.

Thus, by using the function of adding or deleting a specific object that is a detection target of the detection processing performed by the object detector 161, all objects intended by the user can be included within the depth of field as depth-priority objects.

Specific objects are not limited to human faces or animals, but can also include objects such as cars, trains, and airplanes, and specific species of animals such as dogs and cats, or the faces of specific persons such as men and women, can also be used as specific objects. In these cases, specific objects can be detected from image data by using dictionary data machine-learned based on an image of each specific object as training data.

### Adding or Deleting Depth-Priority Objects

In the depth-priority mode, depth-priority objects can be added or deleted by detecting a touch operation as a user operation on the screen of the monitor 150. Instead of detecting the touch operation, a combination of the line of sight of the user gazing at the image displayed on the monitor 150 and a button operation can be detected.

FIG. 5 illustrates image data of a scene in which the persons 501, 502, and 503 are running. The faces of the persons are set as specific objects, with a primary frame 505 superimposed on the face of the person 502 and a secondary frame 504 superimposed on the face of the person 501. However, the face of the person 503 is not detected because it is a profile.

In this embodiment, the user can add the profile of the person 503 to the depth-priority object by touching, or designating, the face of person 503 on the screen of the monitor 150. In this case, the profile of the person 503 can be detected by relaxing the face detection condition so that profile face is also detected at the point touched by the user on the screen of the monitor 150, or by using dictionary data for profile faces in addition to frontal faces.

In addition, the user can touch a person who has already been detected as a depth-priority object on the screen of monitor 150 to remove (exclude) that person from the depth-priority object.

Furthermore, by touching the legs, torso, or other parts of a person whose face has already been detected on the screen of monitor 150, the user can add not only that face of the person but also their legs, torso, or other parts as depth-priority objects.

### Changing (Enlarging, Reducing, Moving) Depth-Priority Object Detecting Area

In the depth-priority mode, the user can enlarge or reduce the depth-priority object detecting area, which is an area in which the object detector 161 detects the depth-priority objects through detection processing, by performing a pinch operation as a user operation, which involves moving two fingers that have touched the screen of monitor 150 closer together or farther apart.

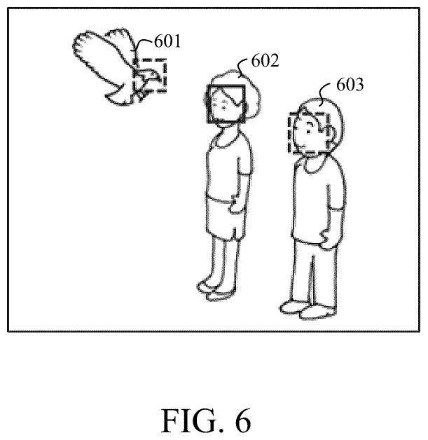

FIG. 6 illustrates a state in which the faces of two persons 602 and 603 and the face of bird 601 are detected by setting a human face and an animal (bird) face as specific objects, and detection frames (main frame and sub-frame) are superimposed on them. In this state, the face of each object is included within the depth of field, but the bodies of the persons 602 and 603 and the wings of the bird 601 may be outside the depth of field. To avoid this, it is necessary to detect the body of the person and the wings of the bird as a single object, including their respective faces.

In this embodiment, the user can expand the detection frame, or the depth-priority object detecting area, by pinching on the screen to widen the detection frame. More specifically, by touching within the detection frame and pinching to widen the detection frame and include the entire body and wings of each object within the detection frame, each object can be entirely detected as a depth-priority object.

In a case where the depth-priority object detecting area is originally set large enough to include the plurality of depth-priority objects, there may be cases where the user wishes to remove part of the plurality of depth-priority objects and add another object to the depth-priority object. In this case, the user may perform a drag operation by sliding their finger across the screen to move the position on the screen without enlarging or reducing the depth-priority object detecting area.

### Defocus Map

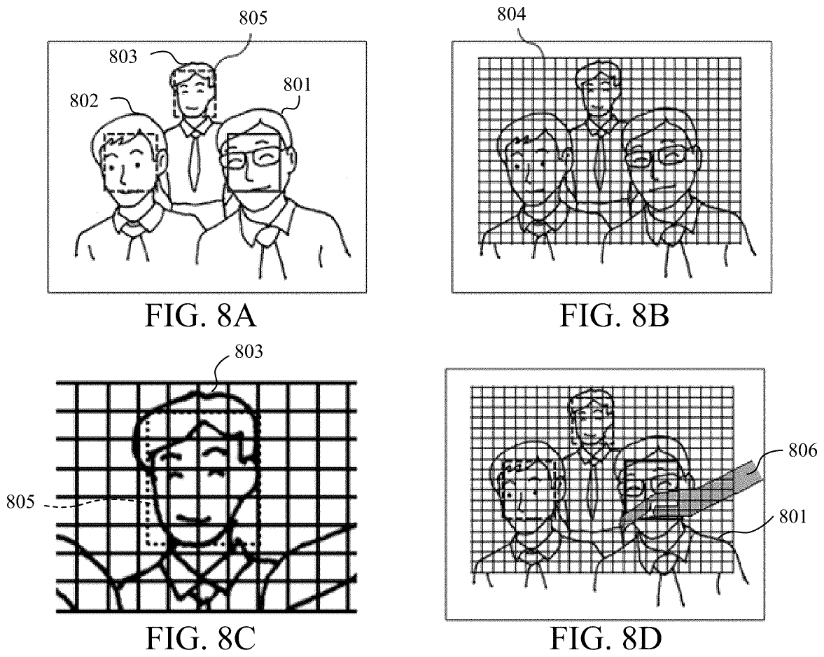

FIG. 8A illustrates the faces of three persons 801, 802, and 803 displayed on the monitor 150, detected as depth-priority objects, with detection frames (e.g., 805) superimposed on them.

FIG. 8B illustrates a defocus map 804 in which a plurality of focus detecting areas are arranged in a grating pattern. The defocus amount for each focus detecting area is calculated by the defocus calculator 165.

The defocus map 804 is disposed to cover the entire detection frame for the depth-priority object, and the size and number of each focus detecting area are set so that a plurality of detection frames are included in one detection frame.

### Representative Defocus Amount

This embodiment arranges a plurality of focus detecting areas for a single depth-priority object, and calculates a representative defocus amount (representative information), which is a single defocus amount representative of the depth-priority object, from the defocus amounts calculated for the plurality of focus detecting areas. This suppresses erroneous calculation of the representative defocus amount due to calculation variations of the defocus amount and eliminates the influence of background other than the specific object, as described below, thereby accurately calculating the representative defocus amount for each depth-priority object (detection frame).

### Suppressing Calculation Variations of Defocus Amount

The calculation result of the defocus amount for individual focus detecting areas often varies due to signal noise, etc. Thus, this embodiment calculates the representative defocus amount for a single detection frame using the calculation result of the defocus amount for a plurality of focus detecting areas arranged within that detection frame. More specifically, the representative defocus amount is determined as a representative value such as the average value of the defocus amount calculation results for the plurality of focus detecting areas arranged within the detection frame, or the most frequent value in creating a histogram using those plurality of defocus amount calculation results.

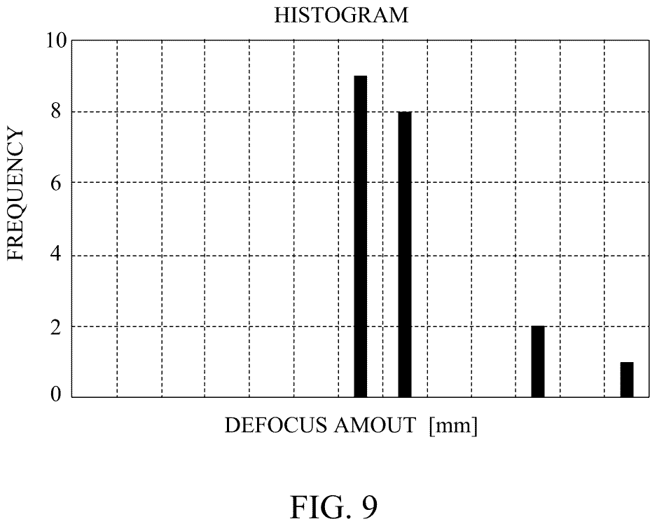

FIG. 9 illustrates an example of a defocus amount histogram. The horizontal axis represents the defocus amount [mm] calculated within a single detection frame, and the vertical axis represents frequency. The most frequent defocus amount is the defocus amount with a frequency of 9, which is designated as the representative defocus amount.

### Eliminating Influence of Background

Using the most frequent value for creating the histogram as the representative defocus amount also has the effect of eliminating the influence of the background. For example, FIG. 8C illustrates an enlarged view of a detection frame 805 and a defocus map 804 displayed over the face of a person 803 as a depth-priority object in FIG. 8A. The detection frame 805 includes a total of 20 focus detecting areas, measuring 5 vertical squares and 4 horizontal squares. FIG. 9 illustrates the histogram for this case.

The most frequent defocus amount in the histogram is a defocus amount calculated for the nine focus detecting areas overlapping the face of the person 803. The defocus amounts that are not the most frequent defocus amount are defocus amounts for focus detecting areas where the background, not the face of the person 803, accounts for a large proportion.

Therefore, using the most frequent defocus amount as the representative defocus amount allows for an accurate defocus amount for the face of the person 803.

The defocus amount targeted by the histogram may be limited to a defocus amount in a focus detecting area that has a superimposition ratio of a predetermined value or greater on the detection frame among the plurality of focus detecting areas.

In calculating the representative defocus amount, an obstacle area present in front of the object and a background area of the object (collectively referred to as a non-object area hereinafter) may be specified, and a defocus amount calculated for the non-object area may be excluded.

The non-object area may be specified using dictionary data in the CNN, or the object area and the non-object area may be distinguished from each other based on changes in the contrast of the object, etc.

FIG. 8D illustrates an example in which a hand 806 of another person as an obstacle overlaps the face of person 801. In this example, the average value of the defocus amounts of the focus detecting areas within the detection frame for the face of the person includes the defocus amount for the hand 806, and a representative defocus amount for the face of the person 801 cannot be accurately calculated.

In a case where the ratio of the hand 806 within the detection frame is small, the defocus amount with the most frequent value on the histogram may be set as the representative defocus amount, but in a case where this ratio is large, the defocus amount with the most frequent value on the histogram becomes the defocus amount for the hand 806. In other words, a representative defocus amount for the face of the person 801 cannot be accurately calculated.

In such a case, the hand 806 is recognized as an obstacle by using dictionary data for detecting an obstacle, and an average value of defocus amounts or the most frequent defocus amount calculated in the focus detecting areas within the detection frame other than the focus detecting area containing the obstacle is set as the representative defocus amount. Thereby, a highly accurate representative defocus amount can be obtained.

In this embodiment, the depth of field is controlled by changing the aperture value of the imaging optical system, but the depth of field may be changed by moving the zoom lens to change the focal length of the imaging optical system. Therefore, the depth of field may be controlled by changing the focal length in addition to or instead of the aperture value. For example, in a case where the depth of field is insufficient even after the aperture value is changed, changing the focal length will change the angle of view, but it is possible to focus on all of the objects intended by the user. A distance range along the optical axis can be changed without changing the depth of field by moving the focus lens to change the focus position of the imaging optical system, and thereby all of the objects intended by the user can be focused on.

In other words, the imaging optical system may be controlled so as to change the depth of field so that all of the objects intended by the user are in focus, such as by changing the aperture value, focal length, and focus position.

### Other Embodiments

Embodiment(s) of the disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium.

The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)TM), a flash memory device, a memory card, and the like. One or more of the functional blocks illustrated in FIG. 1 may be implemented by hardware such as an ASIC or a programmable logic array (PLA), or by a programmable processor such as a CPU or MPU executing software. They may also be implemented by a combination of software and hardware. Therefore, even when different functional blocks are described as the main operation entities in the following description, they may be implemented by the same hardware.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

According to this embodiment, an object intended by a user can be included within a depth of field.

This application claims the benefit of Japanese Patent Application No. 2025-032755, filed on Mar. 3, 2025, and which is hereby incorporated by reference herein in its entirety.

What is claimed is:

1. An image pickup apparatus comprising:
one or more memories storing instructions; and
one or more processors that, upon execution of the instructions, operate to:
detect an object of a type as a detection target selected according to a user operation from image data obtained by imaging through an optical system,
control the optical system so as to include a plurality of objects at different distances within a depth of field of the optical system, and
change the plurality of objects according to the user operation to include an object not detected by detecting the object.

2. The image pickup apparatus according to claim 1, wherein the one or more processors operate to add or change the object of the type as the detection target according to the user operation.

3. The image pickup apparatus according to claim 1, wherein the one or more processors operate to add or change a part of an individual as the detection target by detecting the object according to the user operation.

4. The image pickup apparatus according to claim 1, wherein the one or more processors operate to add an object designated in the image data by the user operation to the plurality of objects.

5. The image pickup apparatus according to claim 1, wherein the one or more processors operate to change an area of the image data in which the object is detected by detecting the object according to the user operation.

6. The image pickup apparatus according to claim 1, wherein the user operation is a touch operation, a pinch operation, or a drag operation on a display unit configured to display the image data.

7. The image pickup apparatus according to claim 1, wherein the one or more processors operate to control an aperture value of the optical system when controlling the optical system.

8. The image pickup apparatus according to claim 1, wherein the one or more processors operate to control the optical system based on defocus information for each object to be included in the depth of field.

9. The image pickup apparatus according to claim 8, wherein the one or more processors operate to use, as the defocus information, representative information on multiple pieces of defocus information obtained for each object.

10. The image pickup apparatus according to claim 9, wherein the one or more processors operate to obtain the representative information by excluding defocus information obtained for a non-object area that does not include the object in the multiple pieces of defocus information.

11. A control method for an image pickup apparatus, the control method comprising:
detecting an object of a type as a detection target selected according to a user operation from image data obtained by imaging through an optical system;
controlling the optical system so as to include a plurality of objects at different distances within a depth of field of the optical system; and
changing the plurality of objects according to the user operation to include an object not detected by the detecting the object.

12. A non-transitory computer-readable storage medium storing a program that causes a computer to execute the control method according to claim 11.
